(19) United States
(12) Patent Application Publication
(10) Pub. No.: US 2006/0093060 A1
(43) Pub. Date: May 4, 2006

(54) MIMO system and method

(75) Inventors: Young-Ho Jung, Seoul (KR); Jae-Hak Chung, Seoul (KR); Seung-Hoon Nam, Seoul (KR); Won-Il Roh, Yongin-si (KR); Jeong-Tae Oh, Yongin-si (KR); Chan-Byoung Chae, Seoul (KR); Kyun-Byoung Ko, Hwaseong-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD, Suwon-si (KR)

(21) Appl. No.: 11/264,186

(22) Filed: Nov. 1, 2005

Related U.S. Application Data
(60) Provisional application No. 60/624,274, filed on Nov. 2, 2004.

(30) Foreign Application Priority Data
Feb. 21, 2005 (KR) 10-2005-0014201

(51) Int. Cl. H04L 1/02

(52) U.S. Cl. 375/267

(57) ABSTRACT

There is provided a Multi-Input Multi-Output (MIMO) communication system including a transmitter for combining at least four transmit antennas according to each of at least two sub-channels, and transmitting space-time-coded signals and at least one receiver for receiving the signals through at least two antennas, wherein the receiver includes an antenna coordination information generator for generating and feeding back optimal transmit antenna coordination information according to said each sub-channel by means of the received signals, and the transmitter includes an antenna coordination controller for controlling coordinations of the transmit antennas according to each sub-channel based on the transmit antenna coordination information fed back from the receiver.

### PRIORITY

This application claims priority to applications entitled “Improved MIMO System and Method” filed in United States Patent and Trademark Office on Nov. 2, 2004 and assigned U.S. provisional application Ser. No. 60/624,274 and filed in the Korean Intellectual Property Office on Feb. 21, 2005 and assigned Serial No. 2005-14201, the contents of which are incorporated herein by reference.

### BACKGROUND OF THE INVENTION

1. Field of the Invention

The present invention relates to a wireless communication system, and more particularly to a Multi-Input Multi-Output (MIMO) communication system using a rate 2 Space-Time Code (STC).

2. Description of the Related Art

In the next generation mobile communication system, an MIMO system using a multiple transmit/receive antenna is gathering strength as an important issue for standardization in transmission schemes for high speed data transmission. A data transmission scheme using an MIMO system may be classified into a Spatial Multiplexing (SM) scheme for transmitting data at high speed without an increase in a bandwidth of a system by simultaneously transmitting different data by means of multiple antennas in a transmitter side, and a Spatial Diversity (SD) scheme for obtaining transmit diversity gain by transmitting the same data through a multiple transmit antenna.

A Space-Time Block Code (STBC), a Space-Time Trellis Code (STTC), etc., belongs to an SD technique proposed for antenna diversity. In a STBC and a STTC, the diversity order increases as the number of transmit antennas increases, but the resulting gain increase is relatively small.

In a SM scheme such as a Vertical Bell Laboratories Layered Space-Time architecture (V-BLAST), the data rate increases in proportional to the number of transmit antennas, but it may be a factor of performance deterioration because there is no diversity gain. Further, there is a limitation in that the number of receive antennas must be greater than or equal to the number of transmit antennas.

In order to compensate for the disadvantages of these two transmission schemes, there has been proposed a transmission technique employing a rate 2 STC, a layered-STBC, or a double STTC, which applies an Alamouti STBC to each antenna coordination with respect to the total four transmit antennas, two transmit antennas of which form one antenna coordination. The rate 2 STC may be expressed by Equation 1. Further, the STC has a coordination of an SD scheme and an SM scheme, thereby showing an improved effect in terms of a diversity gain and a data rate.

$$A = [ \begin{matrix}{s}_{1} & - {s}_{2}^{*} \\ {s}_{2} & {s}_{1}^{*} \\ {s}_{3} & - {s}_{4}^{*} \\ {s}_{4} & {s}_{3}^{*}\end{matrix} ] \qquad ( 1 )$$

A rate 2 STC employing different antenna coordinations according to each sub-channel has been proposed, which may be expressed by Equation 2.

$$B = [ \begin{matrix}{s}_{1} & - {s}_{2}^{*} & {s}_{5} & - {s}_{7}^{*} \\ {s}_{2} & {s}_{1}^{*} & {s}_{6} & - {s}_{8}^{*} \\ {s}_{3} & - {s}_{4}^{*} & {s}_{7} & {s}_{5}^{*} \\ {s}_{4} & {s}_{3}^{*} & {s}_{8} & {s}_{6}^{*}\end{matrix} ] \qquad ( 2 )$$

In the matrix B, the former two columns and the latter two columns correspond to two different sub-channels (or sub-carriers). In this case, a rate of 2 may be maintained at the time at which an additional gain may be obtained through different antenna coordinations according to each sub-channel.

In a coding scheme using the rate 2 STC as described above, it is necessary to acquire channel condition information in order to determine an optimal antenna coordination according to channel conditions.

In relation to a transmission system using the STC of Equation 1, a scheme has been proposed, in which a weight matrix for an optimal antenna coordination is fedback from a terminal and an antenna coordination is set according to the weight matrix.

### SUMMARY OF THE INVENTION

However, a scheme for feeding back a weight matrix may increase the number of calculations in a receiver side and decrease channel efficiency due to enormous feedback information of the weight matrix.

Further, when the scheme for feeding back the weight matrix is applied to a transmission system using the STC of Equation 2, weight matrices must be calculated according to each sub-channel because optimal antenna coordinations are different according to each sub-channel. Therefore, both the calculation amount and the feedback information of the weight matrix are doubled, so that channel efficiency may deteriorate greatly.

Accordingly, the present invention has been made to solve at least the above-mentioned problems occurring in the prior art, and it is an object of the present invention to provide an MIMO system and an MIMO method, in which an optimal antenna coordination is determined based on feedback information from a reception side, thereby maximizing transmission efficiency.

It is another object of the present invention to provide an MIMO system and an MIMO method, in which different antenna coordinations are applied according to each sub-channel, thereby increasing diversity gain without a change in a data rate.

It is further another object of the present invention to provide an MIMO system and an MIMO method, in which a reception side feeds back a weight matrix for determining an optimal antenna coordination in the form of a corresponding index, thereby improving channel efficiency.

It is still another object of the present invention to provide an MIMO system and an MIMO method, in which only a weight matrix for one antenna coordination is used for automatically calculating for an optimal weight matrix for other antenna coordinations with reference to a relation between a plurality of antenna coordinations, thereby improving transmission reliability without increasing the calculation amount and feedback information of the weight matrix.

In order to accomplish the aforementioned object, according to one aspect of the present, there is provided a Multi-Input Multi-Output (MIMO) communication system that includes a transmitter for combining at least four transmit antennas according to each of at least two sub-channels, and transmitting space-time-coded signals; and at least one receiver for receiving the signals through at least two antennas, wherein the receiver includes an antenna coordination information generator for generating and feeding back optimal transmit antenna coordination information according to each sub-channel by means of the received signals, wherein the transmitter includes an antenna coordination controller for controlling coordinations of the transmit antennas according to each sub-channel based on the transmit antenna coordination information fed back from the receiver.

In order to accomplish the aforementioned object, according to another aspect of the present, there is provided a Multi-Input Multi-Output (MIMO) communication method in an MIMO communication system, the MIMO communication system including a transmitter for combining at least four transmit antennas according to each of at least two sub-channels and transmitting signals coded through a space-time coding matrix, and at least one receiver for receiving the signals through at least two antennas, the method includes the steps of receiving antenna coordination information fed back from the receiver; combining the transmit antennas according to each sub-channel based on the antenna coordination information; and transmitting the signals according to the coordination of the transmit antennas.

### BRIEF DESCRIPTION OF THE DRAWINGS

The above and other objects, features and advantages of the present invention will be more apparent from the following detailed description taken in

FIG. 1 is a block diagram illustrating the construction of an MIMO system to which the present invention is applied;

FIG. 2 is a block diagram illustrating an antenna mapping of STCs for a first sub-channel in the transmitter of FIG. 1;

FIG. 3 is a block diagram illustrating an antenna mapping of STCs for a second sub-channel in the transmitter of FIG. 1; and

FIG. 4 is a graph illustrating a result of performance comparison experiment for an MIMO transmission method of the present invention and an MIMO transmission method of the prior art.

### DETAILED DESCRIPTION OF THE PREFERRED EMBODIMENT

Hereinafter, a preferred embodiment according to the present invention will be described with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention.

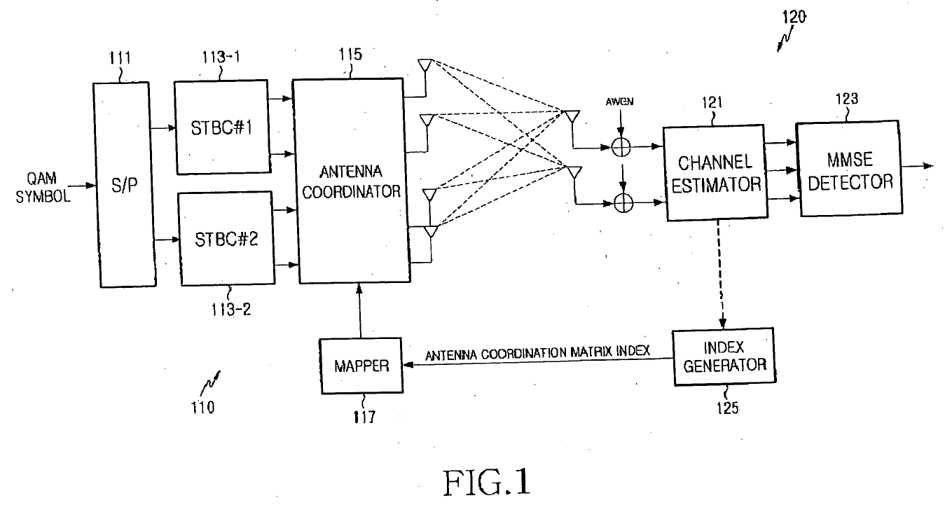

FIG. 1 is a block diagram illustrating the construction of an MIMO system to which the present invention is applied. The MIMO system includes a transmitter 110 having four transmit antennas and a receiver 120 having two receive antennas.

The transmitter 110 includes a serial-to-parallel converter 111, Space-Time Block Coders (STBCs) 113-1 and 113-2, an antenna coordinator 115, and a mapper 117. The serial-to-parallel converter 111 performs a serial-to-parallel conversion for an input modulation symbol sequence, and the STBCs 113-1 and 113-2 spatially multiplex symbols output from the serial-to-parallel converter 111 and perform a space-time block coding for the multiplexed symbols. The antenna coordinator 115 transmits coded symbols output from the STBCs 113-1 and 113-2 through a corresponding antenna according to a corresponding antenna coordination pattern, and the mapper 117 selects an antenna coordination matrix pattern (two antenna coordination matrices) corresponding to an antenna coordination matrix index fedback from the receiver 120, and provides the selected antenna coordination matrix pattern as the antenna coordination pattern of the antenna coordinator 115.

The receiver 120 includes a channel estimator 121, a MMSE detector 123, and an index generator 125. The channel estimator 121 estimates channels by means of signals received through two receive antennas, and the MMSE detector 123 detects and outputs original signals by means of the channels estimated by the channel estimator 121. The index generator 125 detects an optimal transmit antenna coordination by means of information for the estimated channels, generates an antenna coordination matrix index corresponding to the detected optimal transmit antenna coordination, and feeds back the generated antenna coordination matrix index to the transmitter 110. Although the antenna coordination matrix index is shown as sent directly from the index generator 125 in the mapper 117, it is to be understood that the antenna coordination matrix index is transmitted through the antennas from the receiver 120 to the transmitter 110.

The antenna coordinator 115 of the transmitter 110 determines an antenna coordination pattern including optimal antenna coordinations according to the antenna coordination matrix index fedback from the receiver 120, and transmits the coded symbols output from the STBCs 113-1 and 113-2 through the corresponding antenna according to the determined antenna coordination pattern.

The antenna coordination matrix is a weigh matrix for changing antenna coordination, which may be expressed by equation 3.

$$B = [ \begin{matrix}{w}_{11} & {w}_{12} & {w}_{13} & {w}_{14} \\ {w}_{21} & {w}_{22} & {w}_{23} & {w}_{24} \\ {w}_{31} & {w}_{32} & {w}_{33} & {w}_{34} \\ {w}_{41} & {w}_{42} & {w}_{43} & {w}_{44}\end{matrix} ] \qquad ( 3 )$$

From among matrices in which only one element of each row and each column has a value of 1 from the matrix of Equation 3, the following six matrices w₁ to w₆ are used as the antenna coordination matrix in the present invention.

$$\begin{matrix}{w}_{1} = [ \begin{matrix}1 & 0 & 0 & 0 \\ 0 & 1 & 0 & 0 \\ 0 & 0 & 1 & 0 \\ 0 & 0 & 0 & 1\end{matrix} ] , & {w}_{2} = [ \begin{matrix}1 & 0 & 0 & 0 \\ 0 & 1 & 0 & 0 \\ 0 & 0 & 0 & 1 \\ 0 & 0 & 1 & 0\end{matrix} ] , & {w}_{3} = [ \begin{matrix}1 & 0 & 0 & 0 \\ 0 & 0 & 1 & 0 \\ 0 & 1 & 0 & 0 \\ 0 & 0 & 0 & 1\end{matrix} ] , \\ {w}_{4} = [ \begin{matrix}1 & 0 & 0 & 0 \\ 0 & 0 & 1 & 0 \\ 0 & 0 & 0 & 1 \\ 0 & 1 & 0 & 0\end{matrix} ] , & {w}_{5} = [ \begin{matrix}1 & 0 & 0 & 0 \\ 0 & 0 & 0 & 1 \\ 0 & 1 & 0 & 0 \\ 0 & 0 & 1 & 0\end{matrix} ] , & {w}_{6} = [ \begin{matrix}1 & 0 & 0 & 0 \\ 0 & 0 & 0 & 1 \\ 0 & 0 & 1 & 0 \\ 0 & 1 & 0 & 0\end{matrix} ]\end{matrix}$$

In the matrix w, the row index represents an input port of the antenna coordinator 115 and the column index represents an output antenna. From among elements constituting the matrix w, a symbol input through an input port corresponding to an element having a value of 1 is transmitted through a corresponding output antenna. For example, in the matrix w₂, input of a first input port of the antenna coordinator 115 is mapped to a first transmit antenna, input of a second input port is mapped to a second transmit antenna, input of a third input port is mapped to a fourth transmit antenna, and input of a fourth input port is mapped to a third transmit antenna.

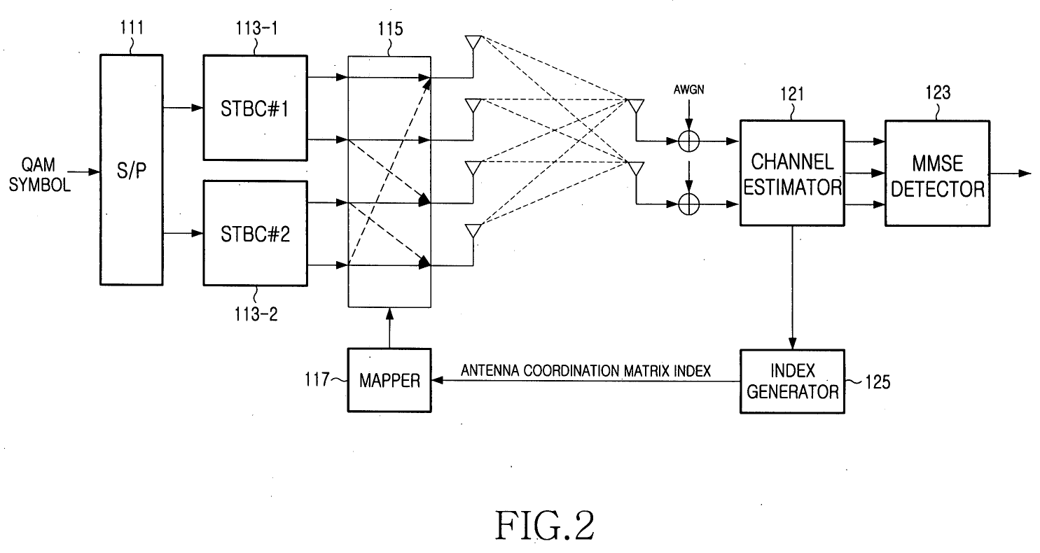

FIG. 2 is a block diagram illustrating an antenna mapping of STCs for a first sub-channel in the transmitter of FIG. 1. The antenna coordinator 115 coordinates antennas according to an antenna coordination matrix corresponding to the first sub-channel with reference to the antenna coordination matrix pattern input from the mapper 117.

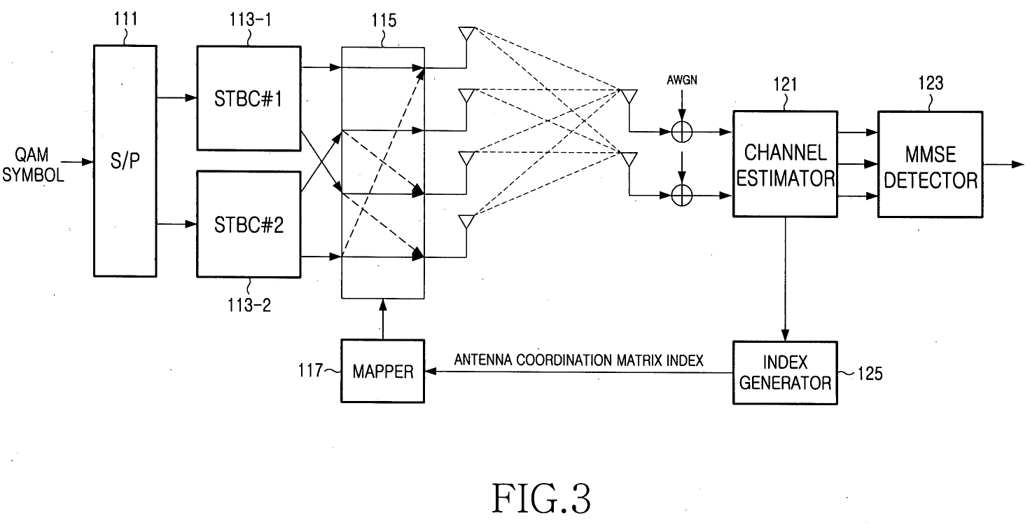

FIG. 3 is a block diagram illustrating an antenna mapping of STCs for a second sub-channel in the transmitter of FIG. 1. First, STCs output from the STBCs 113-1 and 113-2 are input to the antenna coordinator 115 through paths different from those in the case of the first sub-channel. Accordingly, an antenna coordination matrix different from the antenna coordination matrix for the first sub-channel is required. Further, the antenna coordinator 115 coordinates antennas according to an antenna coordination matrix corresponding to the second sub-channel with reference to the antenna coordination matrix pattern input from the mapper 117.

The antenna coordination processes for each sub-channel have been separately described through FIGS. 2 and 3. However, when one antenna coordination matrix index is received from the receiver, the transmitter applies different optimal antenna coordination matrices to the two sub-channels according to the antenna coordination matrix index.

In one embodiment of the present invention, the matrix B of Equation 2 is used as a transmission matrix.

In case of the transmission matrix B, reception signals for the former two columns and reception signals for the latter two columns may be expressed by Equations 4 and 5, respectively.

$$\begin{matrix}[ \begin{matrix}{y}_{11} & {y}_{12} \\ {y}_{21} & {y}_{22}\end{matrix} ] = [ \begin{matrix}{h}_{1 , 1} & {h}_{2 , 1} & {h}_{3 , 1} & {h}_{4 , 1} \\ {h}_{1 , 2} & {h}_{2 , 2} & {h}_{3 , 2} & {h}_{4 , 2}\end{matrix} ] {W}_{opt , 1} [ \begin{matrix}{s}_{1} & - {s}_{2}^{*} \\ {s}_{2} & {s}_{1}^{*} \\ {s}_{3} & - {s}_{4}^{*} \\ {s}_{4} & {s}_{3}^{*}\end{matrix} ] + N & ( 4 ) \\ [ \begin{matrix}{y}_{11} & {y}_{12} \\ {y}_{21} & {y}_{22}\end{matrix} ] = [ \begin{matrix}{h}_{1 , 1} & {h}_{2 , 1} & {h}_{3 , 1} & {h}_{4 , 1} \\ {h}_{1 , 2} & {h}_{2 , 2} & {h}_{3 , 2} & {h}_{4 , 2}\end{matrix} ] {W}_{opt , 2} [ \begin{matrix}{s}_{5} & - {s}_{7}^{*} \\ {s}_{6} & - {s}_{8}^{*} \\ {s}_{7} & {s}_{5}^{*} \\ {s}_{8} & {s}_{6}^{*}\end{matrix} ] + {N}^{′} & ( 5 )\end{matrix}$$

In Equations 4 and 5, the y_{i,j} represents reception signals in a j^{th} symbol interval of an i^{th} receive antenna, and the N and N′ represents noise.

As expressed by Equations 4 and 5, because transmission types of two STCs are different from each other, the W_{opt,1} (an optimal antenna coordination matrix for the former two columns) is different from the W_{opt,2}. The STC of Equation 5 may be expressed by Equation 6.

$$[ \begin{matrix}{s}_{5} & - {s}_{7}^{*} \\ {s}_{6} & - {s}_{8}^{*} \\ {s}_{7} & {s}_{5}^{*} \\ {s}_{8} & {s}_{6}^{*}\end{matrix} ] = [ \begin{matrix}1 & 0 & 0 & 0 \\ 0 & 0 & 1 & 0 \\ 0 & 1 & 0 & 0 \\ 0 & 0 & 0 & 1\end{matrix} ] [ \begin{matrix}{s}_{5} & - {s}_{7}^{*} \\ {s}_{7} & {s}_{5}^{*} \\ {s}_{6} & - {s}_{8}^{*} \\ {s}_{8} & {s}_{6}^{*}\end{matrix} ] \qquad ( 6 )$$

Accordingly, when Equation 6 is combined with Equation 5, the following Equation 7 is obtained.

$$[ \begin{matrix}{y}_{11} & {y}_{12} \\ {y}_{21} & {y}_{22}\end{matrix} ] = [ \begin{matrix}{h}_{1 , 1} & {h}_{2 , 1} & {h}_{3 , 1} & {h}_{4 , 1} \\ {h}_{1 , 2} & {h}_{2 , 2} & {h}_{3 , 2} & {h}_{4 , 2}\end{matrix} ] {W}_{opt , 2}^{′} [ \begin{matrix}1 & 0 & 0 & 0 \\ 0 & 0 & 1 & 0 \\ 0 & 1 & 0 & 0 \\ 0 & 0 & 0 & 1\end{matrix} ] [ \begin{matrix}{s}_{5} & - {s}_{6}^{*} \\ {s}_{6} & {s}_{5}^{*} \\ {s}_{7} & - {s}_{8}^{*} \\ {s}_{8} & {s}_{7}^{*}\end{matrix} ] + {N}^{′} \qquad ( 7 )$$

In this case, because the antenna coordination matrices have the same form, W′_{opt,2}=W_{opt,1}. When this relation is used, the antenna coordination matrix W_{opt,2} for the latter two columns may be expressed by Equation 8.

$${W}_{opt , 2} = {W}_{opt , 1} [ \begin{matrix}1 & 0 & 0 & 0 \\ 0 & 0 & 1 & 0 \\ 0 & 1 & 0 & 0 \\ 0 & 0 & 0 & 1\end{matrix} ] = {W}_{opt , 1} X \qquad ( 8 )$$

Accordingly, only the optimal antenna coordination matrix W_{opt,1} for the former two columns in the matrix B is calculated, so that the optimal antenna coordination matrix W_{opt,2} for the remaining two columns can be acquired.

When coordinations of two antennas are generated by bundling every two transmit antennas from among four transmit antennas by means of the transmission matrix B, an antenna-mapping rule for two transmission matrix types is presented in Table 1 below.

TABLE 1

| Former two | Latter two | Former two | Latter two |
|---|---|---|---|
| columns in B | columns in B | columns in B | columns in B |
| (1, 2), (3, 4) | (1, 3), (2, 4) | (3, 1), (2, 4) | (2, 1), (3, 4) |
| (1, 2), (4, 3) | (1, 3), (4, 2) | (3, 1), (4, 2) | (2, 1), (4, 3) |
| (1, 3), (2, 4) | (1, 2), (3, 4) | (3, 2), (1, 4) | (2, 3), (1, 4) |
| (1, 3), (4, 2) | (1, 2), (4, 3) | (3, 2), (4, 1) | (2, 3), (4, 1) |
| (1, 4), (2, 3) | (1, 4), (3, 2) | (3, 4), (1, 2) | (2, 4), (1, 3) |
| (1, 4), (3, 2) | (1, 4), (2, 3) | (3, 4), (2, 1) | (2, 4), (3, 1) |
| (2, 1), (3, 4) | (3, 1), (2, 4) | (2, 1), (3, 4) | (3, 1), (2, 4) |
| (2, 1), (4, 3) | (3, 1), (4, 2) | (2, 1), (4, 3) | (3, 1), (4, 2) |
| (2, 3), (1, 4) | (3, 2), (1, 4) | (2, 3), (1, 4) | (3, 2), (1, 4) |
| (2, 3), (4, 1) | (3, 2), (4, 1) | (2, 3), (4, 1) | (3, 2), (4, 1) |
| (2, 4), (1, 3) | (3, 4), (1, 2) | (2, 4), (1, 3) | (3, 4), (1, 2) |
| (2, 4), (3, 1) | (3, 4), (2, 1) | (2, 4), (3, 1) | (3, 4), (2, 1) |

In Table 1, (1, 2) (4, 3) represents that the first row and the second row in the transmission matrix correspond to an antenna #1 and an antenna #2, respectively, the third row correspond to an antenna #4, and the fourth row correspond to an antenna #3.

In one embodiment of the present invention, the matrix B is used as the transmission matrix. However, the scope of the present invention is not limited to the matrix. That is, it is apparent to those skilled in the art that various types of matrices may be used as the transmission matrix. In this case, when the matrix X is obtained so that transmission matrix types are equalized after multiplication with the matrix X, it is possible to obtain an optimal antenna coordination matrix for remaining transmission matrices through only a single feedback result using Equation 8.

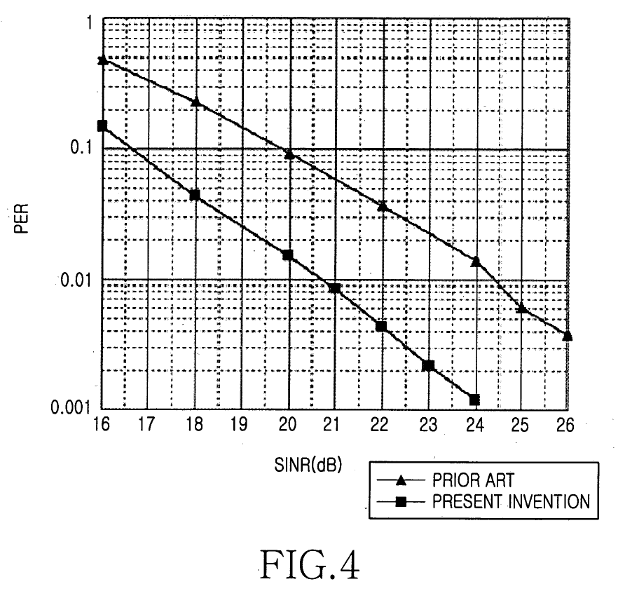

FIG. 4 is a graph illustrating a result of performance comparison experiment for an MIMO transmission method of the present invention and an MIMO transmission method of the prior art. It can be understood that the MIMO transmission method of the present invention shows a significant performance improvement in terms of a Packet Error Rate (PER), as compared with the conventional feedback-based MIMO transmission method.

According to the present invention as described above, different antenna coordinations are applied according to each sub-channel, thereby increasing diversity gain without a change in a data rate.

Further, according to the present invention as described above, a reception side feeds back a weight matrix for determining an optimal antenna coordination in the form of a corresponding index, thereby reducing feedback information and thus improving channel efficiency.

Furthermore, according to the present invention as described above, only a weight matrix for one antenna coordination is used for automatically calculating for an optimal weight matrix of other antenna coordinations for different sub-channels with reference to a correlation between a plurality of antenna coordinations, thereby improving transmission reliability without increasing the calculation amount and feedback information of the weight matrix.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A Multi-Input Multi-Output (MIMO) communication system, comprising:
a transmitter for combining at least four transmit antennas according to each of at least two sub-channels, and transmitting space-time-coded signals; and
at least one receiver for receiving the signals through at least two antennas,
wherein the receiver includes an antenna coordination information generator for generating and feeding back optimal transmit antenna coordination information according to each sub-channel by means of the received signals, and
wherein the transmitter includes an antenna coordination controller for controlling coordinations of the transmit antennas according to each sub-channel based on the transmit antenna coordination information fedback from the receiver.

2. The system as claimed in claim 1, wherein the transmit antenna coordination information includes coordination matrices of the transmit antennas according to each sub-channel.

3. The system as claimed in claim 1, wherein the transmit antenna coordination information includes preset indices corresponding to coordination matrices of the transmit antennas according to each sub-channel.

4. The system as claimed in claim 1, wherein the transmit antenna coordination information includes coordination matrices of the transmit antennas for one sub-channel of the at lest two sub-channels.

5. The system as claimed in claim 4, wherein the antenna coordination controller detects coordination matrices of transmit antennas for a remaining sub-channel by means of the coordination matrices.

6. The system as claimed in claim 1, wherein the transmit antenna coordination information includes preset indices corresponding to coordination matrices of the transmit antennas for one sub-channel of the at least two sub-channels.

7. The system as claimed in claim 6, wherein the antenna coordination controller coordinates the transmit antennas according to coordination matrices corresponding to the indices.

8. A Multi-Input Multi-Output (MIMO) communication method in an MIMO communication system, the MIMO communication system including a transmitter for combining at least four transmit antennas according to each of at least two sub-channels and transmitting signals coded through a space-time coding matrix, and at least one receiver for receiving the signals through at least two antennas, the method comprising the steps of:
receiving antenna coordination information fedback from the receiver;
combining the transmit antennas according to each sub-channel based on the antenna coordination information; and
transmitting the signals according to the coordination of the transmit antennas.

9. The method as claimed in claim 8, wherein the antenna coordination information includes antenna coordination matrices representing an optimal antenna coordination according to each sub-channel.

10. The method as claimed in claim 8, wherein the antenna coordination information includes indices corresponding to antenna coordination matrices representing an optimal antenna coordination according to each sub-channel.

11. The method as claimed in claim 8, wherein the antenna coordination information includes indices corresponding to an antenna coordination matrix set having antenna coordination matrices which represent an optimal antenna coordination according to each sub-channel.

12. The method as claimed in claim 8, wherein the antenna coordination information includes an antenna coordination matrix for one sub-channel from among antenna coordination matrices representing an optimal antenna coordination according to each sub-channel.

13. The method as claimed in claim 12, wherein an antenna coordination matrix for a remaining sub-channel is obtained using the fedback antenna coordination matrix.

14. The method as claimed in claim 8, wherein the antenna coordination information includes an index for an antenna coordination matrix for one sub-channel from among antenna coordination matrices representing an optimal antenna coordination according to each sub-channel.

15. The method as claimed in claim 14, wherein an antenna coordination matrix for a remaining sub-channel is obtained using an antenna coordination matrix determined by the index.
